(19) United States
(12) Patent Application Publication
(10) Pub. No.: US 2015/0024622 A1
(43) Pub. Date: Jan. 22, 2015

(54) Dimm Connector

(71) Applicant: LOTES CO., LTD, Keelung (TW)

(72) Inventor: Zuo Feng Jin, Keelung (TW)

(73) Assignee: LOTES CO., LTD, Keelung (TW)

(21) Appl. No.: 14/047,504

(22) Filed: Oct. 7, 2013

(30) Foreign Application Priority Data
Jul. 19, 2013 (CN) 201320429885.8

(51) Int. Cl. H01R 13/627; H01R 12/70

(52) U.S. Cl. CPC H01R 13/6273; H01R 12/7082
USPC 439/355

(57) ABSTRACT

A Dual Inline Memory Module (DIMM) connector includes an electrical receptacle, a first fastening member and a second fastening member. A mating end of the electrical receptacle has a first slot and a second slot for receiving a first and a second DIMM modules to be inserted therein, respectively. The first fastening member has a first pressing portion for pressing the first DIMM module, a first clasping portion for clasping a positioning hole at a side edge of the first DIMM module, and a second clasping portion clasped at a rear edge of the second DIMM module. The second fastening member has a second pressing portion for pressing the second DIMM module. When the first DIMM module is mounting in the first slot, the second clasping portion does not hinder the first DIMM module.

### CROSS-REFERENCE TO RELATED APPLICATION

This non-provisional application claims priority under 35 U.S.C. §119(a) on Patent Application No. 201320429885.8 filed in China on Jul. 19, 2013, the entire contents of which are hereby incorporated by reference.

Some references, if any, which may include patents, patent applications and various publications, are cited in a reference list and discussed in the description of this invention. The citation and/or discussion of such references is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to a Dual Inline Memory Module (DIMM) connector, and more particularly to a DIMM connector electrically connecting two DIMM modules to a circuit board.

### BACKGROUND OF THE INVENTION

A so-called DIMM connector refers to a DIMM connector complying with standards of the Joint Electron Device Engineering Council (JEDEC) Solid State Technology Association. Two sides of a DIMM module matching the DIMM connector are each provided with a positioning hole. DIMM modules matching the DIMM connector generally have three different sizes. That is, there are three different sizes between a front edge (a side having a golden finger) of the DIMM module and a rear edge (an opposite side). However, for the DIMM modules of the three different sizes, a distance from a positioning hole at a side edge to the front edge (the side having the golden finger) is the same. Thus, in order to make adaptation to the DIMM modules having the three different distances between the front and rear edges, technicians generally dispose a clasping portion of a fastening member of the DIMM connector in a position corresponding to the positioning hole at the side edge of the DIMM module according to the JEDEC standards. That is, generally, the DIMM module is positioned in the DIMM connector by clasping the positioning hole at the side edge of the DIMM module. The structure thereof generally includes an insulating body having a slot, and a pair of fastening members fixed on two ends of the slot respectively. The fastening member includes a pressing portion that presses the DIMM module mounted in the slot to prevent the DIMM module from moving upwards, and a clasping portion clasped in the positioning hole at the side edge of the DIMM module mounted in the slot to prevent the DIMM module from withdrawing outwards.

However, with the advances and development of science and technology, the amount of information delivered and processed by an electronic product increases constantly. Therefore, disposing one DIMM module on an electronic product is obviously unable to meet requirements, and technicians may dispose a DIMM connector that is capable of inserting at least two DIMM modules on a circuit board. A common structure thereof generally includes a first insulating body having a first slot and a second insulating body having a second slot, for receiving the two DIMM modules to be inserted therein. The first insulating body and the second insulating body are disposed in a front and back manner, and the second insulating body is higher than the first insulating body. A pair of first fastening members is fixed on two ends of the first slot respectively. The first fastening member includes a first pressing portion pressing the DIMM module mounted in the first slot to prevent the DIMM module from moving upwards, and a first clasping portion clasped in the positioning hole at the side edge of the DIMM module mounted in the first slot to prevent the DIMM module from withdrawing outwards. A pair of second fastening members is fixed on two ends of the second slot respectively. The second fastening member includes a second pressing portion pressing the DIMM module mounted in the second slot to prevent the second DIMM module from moving upwards, and a second clasping portion clasped in the positioning hole at the side edge of the DIMM module mounted in the second lot to prevent the DIMM module from withdrawing outwards.

Although the DIMM connector can electrically connect two DIMM modules to a circuit board at the same time, the DIMM connector has the following defects. When mounting a DIMM module in the first slot, the second clasping portion hinders the DIMM module. Therefore, for smoothly mounting the DIMM module in the first slot, the two second fastening members have to be pulled outwards. The operation is difficult with only two hands, which makes it difficult to mount the DIMM module in the first slot.

Therefore, a heretofore unaddressed need exists in the art to address the aforementioned deficiencies and inadequacies.

### SUMMARY OF THE INVENTION

In one aspect, the present invention is directed to a DIMM connector, which can effectively solve the problem of difficulty in mounting a DIMM module in a first slot.

In one embodiment, a DIMM connector includes an electrical receptacle, at least one first fastening member, at least one second fastening member, and at least one second clasping portion. A mating end of the electrical receptacle has a first slot and a second slot that are disposed in a front and back manner for receiving a first DIMM module and a second DIMM module to be inserted therein, respectively. The second slot is higher than the first slot. The first fastening member has a first pressing portion and a first clasping portion. The first pressing portion is used to press the first DIMM module, and the first clasping portion is used to clasp the first DIMM module to prevent the first DIMM module from withdrawing outwards. The second fastening member has a second pressing portion used to press the second DIMM module. The second clasping portion is clasped at a rear edge of the second DIMM module to prevent the second DIMM module from withdrawing outwards.

Further, the first fastening member includes a first fixing portion fixed at one end of the first slot and a first arm portion extending forwards from the first fixing portion.

Further, the first pressing portion and the first clasping portion are located on the first arm portion.

Further, the second clasping portion is formed by bending and extending upwards from an upper edge of the first arm portion. When the first DIMM module is mounted in the first slot, the second clasping portion correspondingly passes through a positioning hole at a side edge of the first DIMM module.

Further, with a direction facing the first slot being inward, the first arm portion bends and extends inwards to form a first extension plate. The first extension plate has a first support portion used to support upwards the first DIMM module.

Further, the first extension plate bends and extends outwards and upwards to form a first stop arm. The first stop arm crosses the first arm portion. The first stop arm is capable of stopping the first arm portion from moving outwards excessively.

Further, the second fastening member includes a second fixing portion fixed at one end of the second slot and a second arm portion extending forwards from the second fixing portion.

Further, with a direction facing the second slot being inward, the second arm portion bends and extends inwards to form a second extension plate. The second extension plate has a second support portion supporting the second DIMM module. The second extension plate bends and extends outwards and upwards to form a second stop arm. The second stop arm is capable of stopping the second arm portion from moving outwards excessively.

Further, the second extension plate further has a second soldering portion. The second soldering portion is formed by bending and extending outwards and downwards horizontally from a bottom edge of the second extension plate.

Further, the second pressing portion is located on the second arm portion, and a vertical projection of the second clasping portion completely falls within a vertical projection area of the positioning hole of the side edge of the first DIMM module.

Further, the number of the first fastening members and the number of the second fastening members are both 2. The two first fastening members are disposed at two ends of the first slot respectively and opposite to each other. The two second fastening members are disposed at two ends of the second slot respectively and opposite to each other.

In one embodiment, a DIMM connector includes an electrical receptacle, and at least one first fastening member. A mating end of the electrical receptacle has a first slot and a second slot that are horizontally and vertically staggered and are used for receiving a first DIMM module and a second DIMM module to be inserted therein respectively. The at least one first fastening member includes a first fixing portion fixed at one end of the first slot and a first arm portion extending forwards from the first fixing portion to the front of the first slot. The first arm portion has a first clasping portion used to prevent the first DIMM module from withdrawing outwards, and a second clasping portion, located above the first clasping portion. The second clasping portion and the first clasping portion are disposed one above the other, and the second clasping portion is clasped at a rear edge of the second DIMM module to prevent the second DIMM module from withdrawing outwards.

The DIMM connector further includes at least one second fastening member. The second fastening member includes a second fixing portion fixed at one end of the second slot and a second arm portion extending forwards from the second fixing portion to the front of the second slot.

Further, the number of the first fastening members and the number of the second fastening members are both 2. The two first fastening members are disposed at two ends of the first slot respectively and opposite to each other. The two second fastening members are disposed at two ends of the second slot respectively and opposite to each other.

Further, the second arm portion has a second pressing portion used to prevent the second DIMM module from moving upwards.

Further, the first arm portion further includes a first pressing portion used to prevent the first DIMM module from moving upwards.

Further, the second clasping portion is located on the first fastening member, and is formed by bending and extending upwards from an upper edge of the first arm portion.

Further, the first clasping portion is clasped in a positioning hole at a side edge of the first DIMM module, and a vertical projection of the second clasping portion completely falls within a vertical projection area of the positioning hole.

Further, during an insertion process in which the first DIMM module is mounted in the first slot, the second clasping portion correspondingly passes through a positioning hole at a side edge of the first DIMM module.

Compared with the related art, the DIMM connector according to certain embodiments of the present invention has the following beneficial effects.

The second clasping portion is located at the rear edge of the second DIMM module. When the first DIMM module is mounted in the first slot, the second clasping portion does not hinder the first DIMM module from being mounted in the first slot. Accordingly, there is no need to pull the two second fastening members to two sides, thereby making it easier and more convenient to mount the first DIMM module in the first slot, and incurring no such trouble as that two hands are not sufficient.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention.

Wherever possible, the same reference numbers are used throughout the drawings to refer to the same or like elements of an embodiment, and wherein:

FIG. 1 is a three dimensional exploded view of a DIMM connector according to one embodiment of the present invention;

FIG. 2 is a three dimensional combined view of a DIMM connector according to one embodiment of the present invention;

FIG. 3 is an initial state view of a DIMM module mounted in a first slot according to one embodiment of the present invention;

FIG. 4 is a process view of mounting a DIMM module in a first slot according to one embodiment of the present invention;

FIG. 5 is a schematic view of a DIMM module mounted and fixed in a first slot according to one embodiment of the present invention;

FIG. 6 is an initial state view of a DIMM module mounted in a second slot according to one embodiment of the present invention;

FIG. 7 is a schematic view of a DIMM module mounted and fixed in a second slot according to one embodiment of the present invention; and

FIG. 8 is a top view of FIG. 7.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

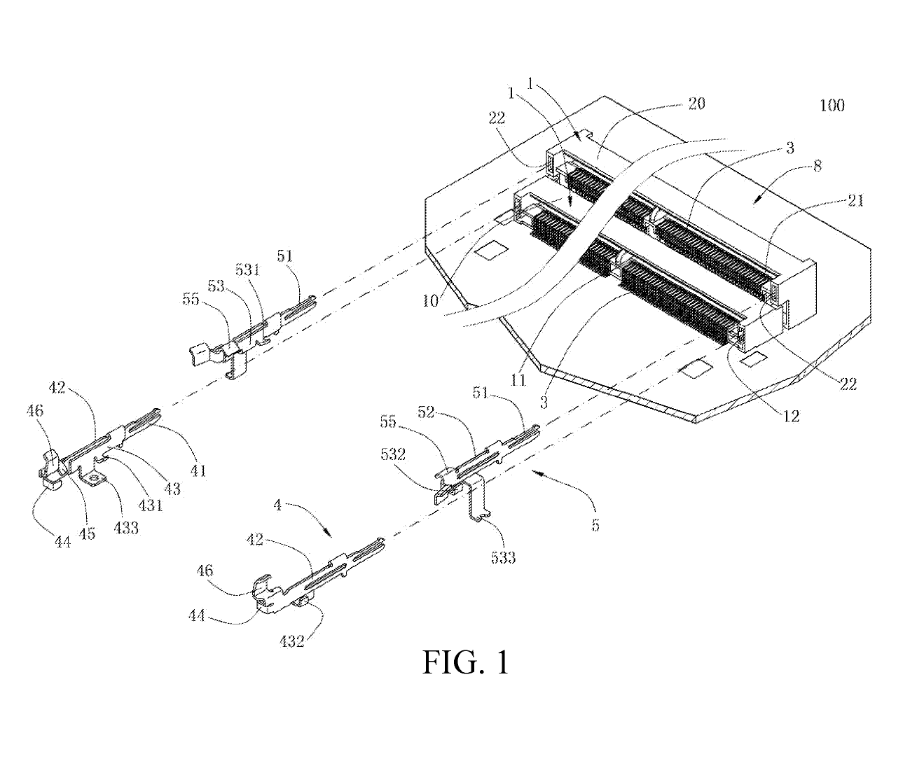

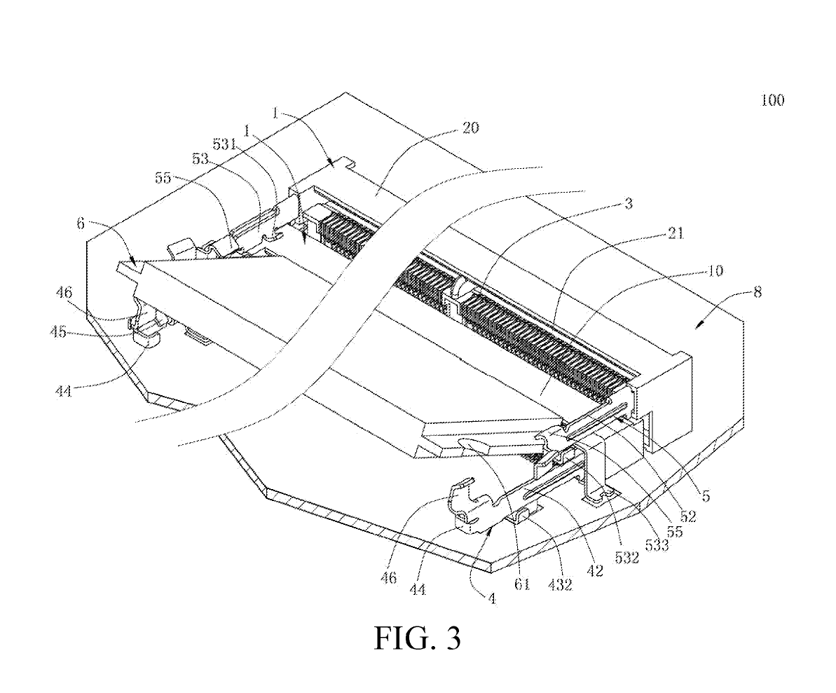

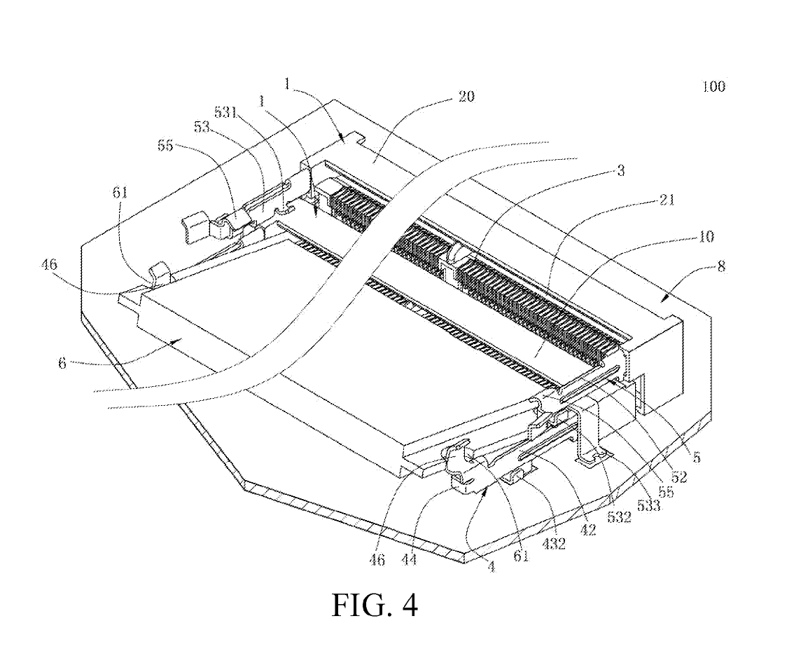

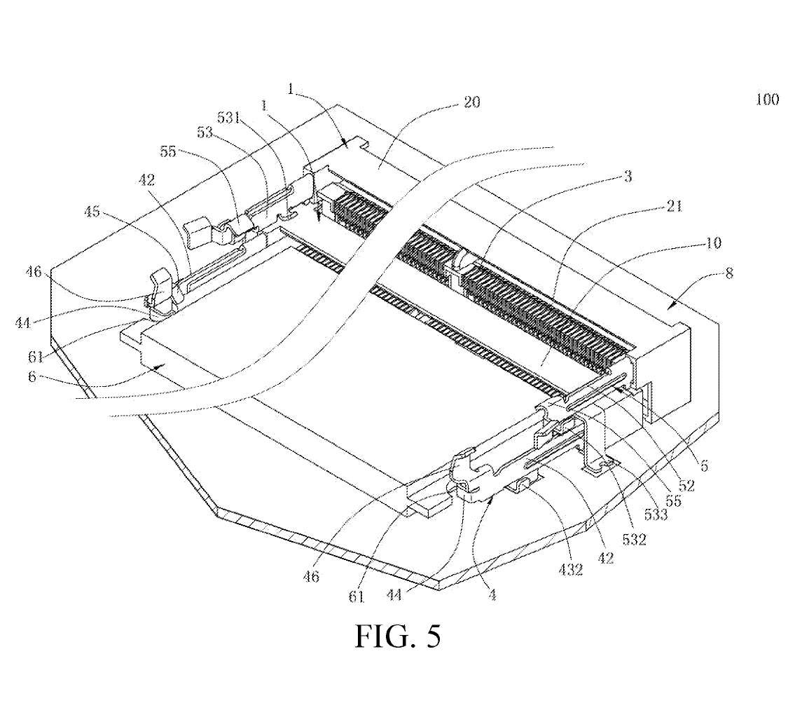

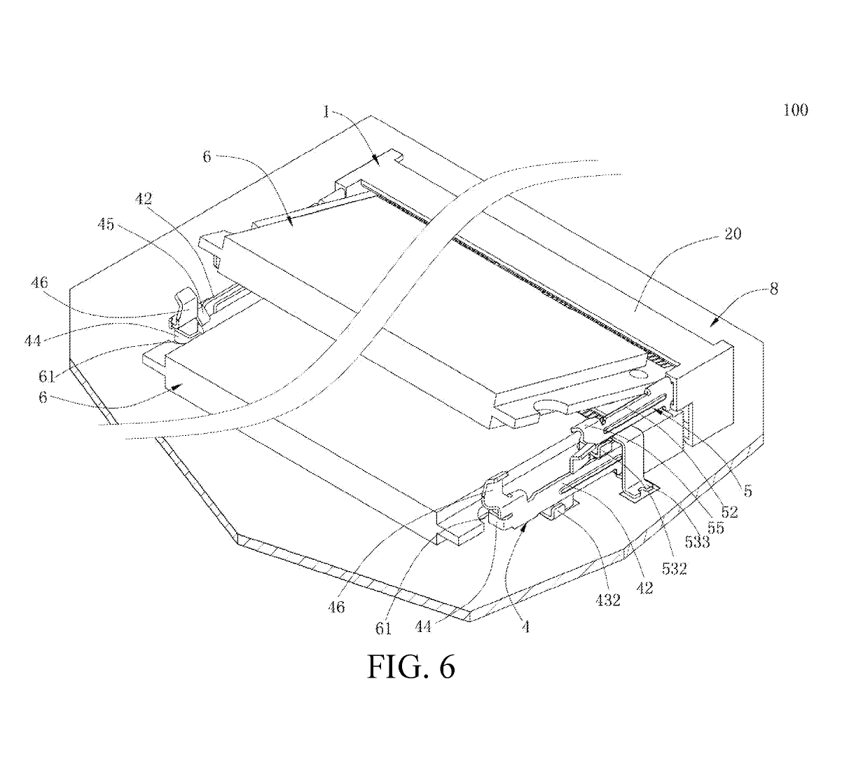

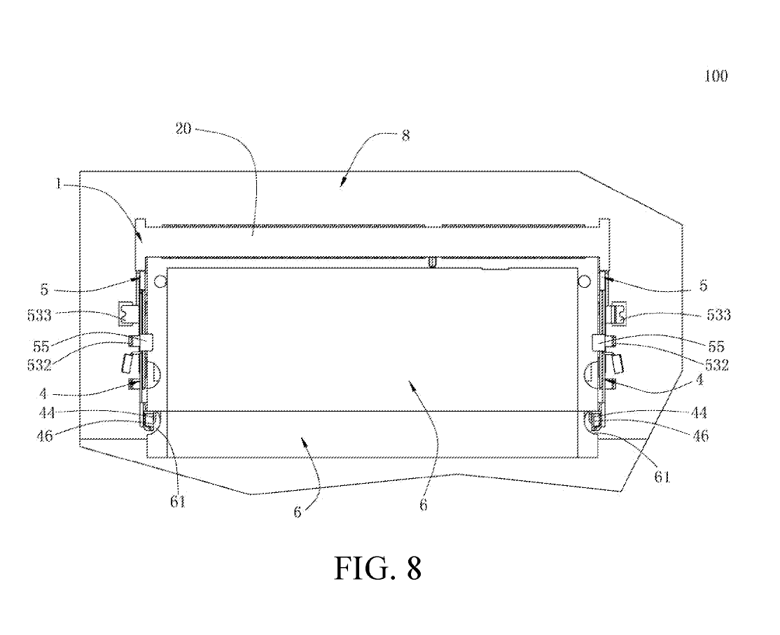

A DIMM connector 100 of the present invention is further illustrated below with reference to FIGS. 1-8 and embodiments.

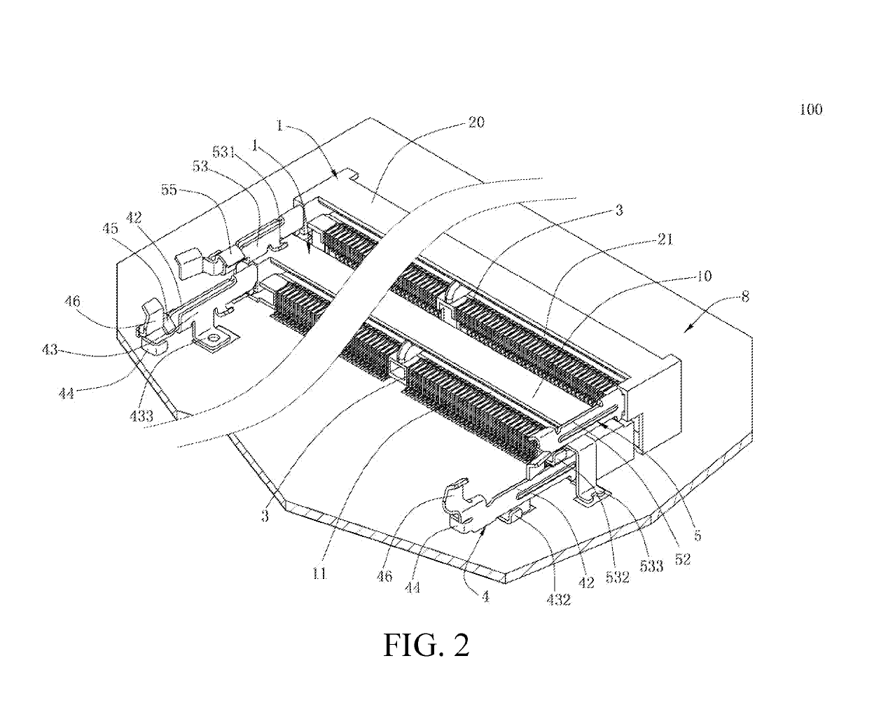

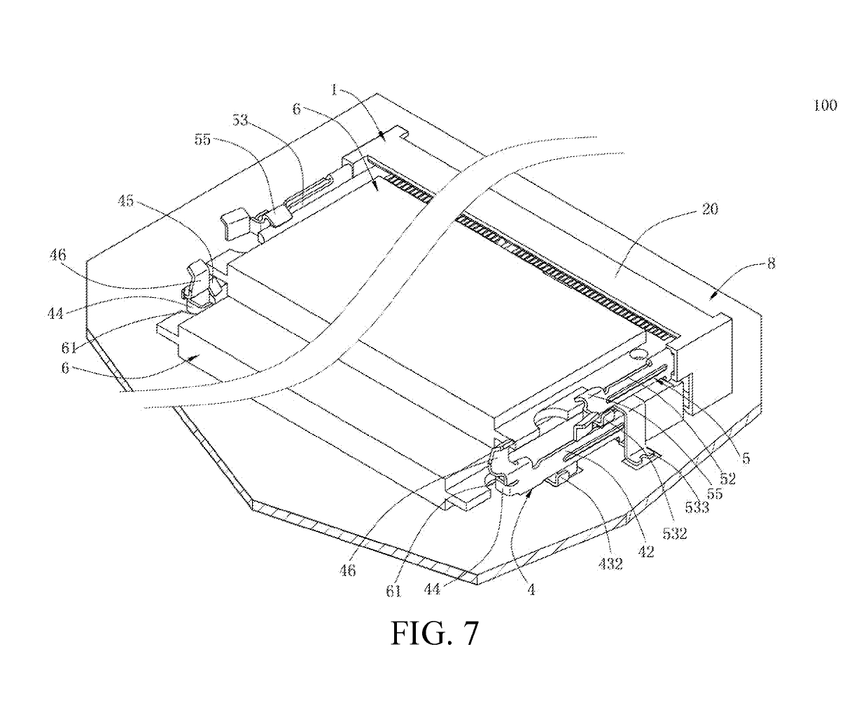

Referring to FIG. 2 and FIG. 7, certain embodiments of the present invention provides a DIMM connector 100, which is soldered to a circuit board 8, so that two DIMM modules 6 can be inserted into the DIMM connector 100 respectively, and therefore the two DIMM modules 6 are electrically connected to the circuit board 8 through the DIMM connector 100. The DIMM connector 100 includes an electrical receptacle 1. The electrical receptacle 1 includes a first insulating body 10. The first insulating body 10 is in the shape of a longitudinally-long rectangular body. A first slot 11 is provided along a longitudinal direction of the first insulating body 10 and is for insertion and fixation of one of the two DIMM modules 6. Two first fastening members 4 are symmetrically disposed at two ends of the first slot 11 respectively, used for limiting and fixing the DIMM module 6 located in the first slot 11. The electrical receptacle 1 further includes a second insulating body 20. The second insulating body 20 is also in the shape of a longitudinally-long rectangular body. A second slot 21 is provided along a longitudinal direction of the second insulating body 20 and is for insertion and fixation of the other one of the two DIMM modules 6. Two second fastening members 5 are symmetrically disposed at two ends of the second slot 21 respectively, used for limiting and fixing the DIMM module 6 located in the second slot 21. Alternatively, the design is not limited thereto. The first insulating body 10 and the second insulating body 20 may also be integrally formed. It may also be set that a first fastening member 4 and a second fastening member 5 are fixed on one end of the first slot 11 and one end of the second slot 21, respectively.

Referring to FIG. 1 and FIG. 7, the second insulating body 20 is located above the first insulating body 10, so that the second slot 21 and the first slot 11 are disposed one above the other. Upper and lower sides of the first slot 11 and the second slot 21 are each provided with multiple terminals 3, so as to respectively connect the two DIMM modules 6 to the circuit board 8. Two ends of the first insulating body 10 are each provided with a first accommodation slot 12 that is recessed, and two ends of the second insulating body 20 are each provided with a second accommodation slot 22 that is recessed. The first accommodation slots 12 are also correspondingly located at the two ends of the first slot 11, and the second accommodation slots 22 are also correspondingly located at the two ends of the second slot 21. The first accommodation slot 12 and the second accommodation slot 22 are used to receive and fix the first fastening member 4 and the second fastening member 5 respectively. Alternatively, the design is not limited thereto, and when the DIMM connector 100 is provided with only one first fastening member 4 and only one second fastening member 5, it is only required that one end of the first insulating body 10 and one end of the second insulating body 20 are provided with the first accommodation slot 12 and the second accommodation slot 22 respectively which are recessed.

Referring to FIG. 1, the first fastening member 4 is of an integral metal member structure made through a metal sheet integral stamping process. Each first fastening member 4 includes a first fixing portion 41 fixed in the first insulating body 10. A first arm portion 42 extends forwards from the first fixing portion 41. Similarly, the second fastening member 5 is of an integral metal member structure made through a metal sheet integral stamping process. Each second fastening member 5 includes a second fixing portion 51 fixed in the second insulating body 20. A second arm portion 52 extends forwards from the second fixing portion 51. Each first fixing portion 41 and each second fixing portion 51 are in the shape of a fork, and correspondingly received and fixed in the first accommodation slot 12 and the second accommodation slot 22 respectively. Structures of the first arm portion 42 and the second arm portion 52 are illustrated below in detail.

Referring to FIGS. 2, 7 and 8, with a direction facing the first slot 11 being inward, the first arm portion 42 bends and extends inwards to form a first extension plate 43. A lower edge of the first extension plate 43 bends and extends inwards and upwards to form a first support portion 431. The first support portion 431 supports upwards the

DIMM module 6 mounted in the first slot 11. A lower edge at a rear end of the first extension plate 43 bends and extends outwards and upwards to form a first stop arm 432. A top end of the first stop arm 432 is higher than a lower edge of the first arm portion 42 and is spaced from the first arm portion 42 by a gap. The first stop arm 432 is used to stop the first arm portion 42 from moving outwards excessively. The first extension plate 43 is further provided with a first soldering portion 433. The first soldering portion 433 is located between the first support portion 431 and the first stop arm 432 and is formed by bending and extending downwards and horizontally from the lower edge of the first extension plate 43. A first clasping portion 44 is disposed by bending inwards and backwards from a free rear end of the first arm portion 42. The first clasping portion 44 is clasped in a positioning hole 61 at a side edge of the DIMM module 6 mounted in the first slot 11 to prevent the DIMM module 6 from withdrawing outwards. A second clasping portion 46 is formed by bending and extending inwards and upwards from an upper edge of the free rear end of the first arm portion 42. The second clasping portion 46 is located right above the first clasping portion 44 and is clasped at a rear edge of the DIMM module 6 mounted in the second slot 21 to prevent the DIMM module 6 from withdrawing outwards. A vertical projection of the second clasping portion 46 is located in a vertical projection area of the positioning hole 61 of the side edge of the DIMM module 6 mounted in the first slot 11. The first arm portion 42 is provided with a first pressing portion 45 behind the second clasping portion 46. The first pressing portion 45 is used to press the DIMM module 6 mounted in the first slot 11 to prevent the DIMM module 6 from moving upwards. With a direction facing the second slot 21 being inward, the second arm portion 52 bends and extends inwards to form a second extension plate 53. A lower edge of the second extension plate 53 bends and extends inwards and upwards to form a second support portion 531. The second support portion 531 supports upwards the DIMM module 6 mounted in the second slot 21. A second stop arm 532 bends and extends outwards and upwards from a lower edge of a rear end of the second extension plate 53. A top end of the second stop arm 532 is higher than a lower edge of the second arm portion 52 and is spaced from the second arm portion 52 by a gap. The second stop arm 532 is used to stop the second arm portion 52 from moving outwards excessively. The second extension plate 53 is further provided with a second soldering portion 533. The second soldering portion 533 is located between the second support portion 531 and the second stop arm 532 and is formed by bending and extending outwards and downwards from the lower edge of the second extension plate 53. The second arm portion 52 bends and extends inwards and downwards from an upper edge at the rear end of the second extension plate 53 to form a second pressing portion 55. The second pressing portion 55 is used to press the DIMM module 6 mounted in the second slot 21 to prevent the DIMM module 6 from moving upwards. Therefore, the two DIMM modules 6 are limited and fixed between two first arm portions 42 and between two second arm portions 52 respectively. Alternatively, in another embodiment, the second clasping portion 46 is disposed at a free rear end of the second arm portion 52. The second clasping portion 46 is formed by extending vertically forwards from a front end of the second pressing portion 55 and then bending and extending inwards. The second clasping portion 46 is clasped at the rear edge of the DIMM module 6 mounted in the second slot 21, and a vertical projection thereof is also located in a vertical projection area of the positioning hole 61 of the side edge of the DIMM module 6 mounted in the first slot 11.

Referring to FIGS. 2-7, a general process of fixing the two DIMM modules 6 on the DIMM connector 100 is as follows.

First, one of the two DIMM modules 6 is correspondingly inserted, from below the second pressing portion 55 and in an angle of inclination, into the first slot 11, and one end away from the first insulating body 10 is inclined upwards.

Then, the DIMM module 6 is pressed downwards. The second clasping portion 46 correspondingly passes through the positioning hole 61 at the side edge of the DIMM module 6. The DIMM module 6 is further pressed downwards, the first arm portion 42 is urged outwards. The DIMM module 6 enters between the two first arm portions 42. The first pressing portion 45 presses downwards the DIMM module 6 to prevent the DIMM module 6 from moving upwards, and meanwhile, the first clasping portion 44 is clasped in the positioning hole 61 at the side edge of the DIMM module 6 to prevent the DIMM module 6 from withdrawing outwards. Therefore, the one of the two DIMM modules 6 is limited and fixed between the two first arm portions 42.

Then, the other one of the two DIMM modules 6 is correspondingly inserted, in an angle of inclination, into the second slot 21, and one end away from the second insulating body 20 is inclined upwards. Then, the DIMM module 6 is pressed downwards to urge the two second arm portions 52 outwards. The DIMM module 6 enters between the two second arm portions 52. The second pressing portion 55 presses downwards the DIMM module 6 to prevent the DIMM module 6 from moving upwards, and the second clasping portion 46 is clasped at the rear edge of the DIMM module 6 to prevent the DIMM module 6 from withdrawing outwards. Therefore, the other one of the two DIMM modules 6 is limited and fixed between the two second arm portions 52.

In view of the above, the DIMM connector 100 according to certain embodiment of the present invention, among other things, has the following beneficial effects.

I. The second clasping portion 46 is located at the rear edge of the DIMM module 6 mounted in the second slot 21. When the DIMM module 6 is mounted in the first slot 11, the second clasping portion 46 does not hinder the DIMM module 6 from being mounted in the first slot 11. Therefore, there is no need to pull the two second fastening members 5 to two sides, thereby making it easier and more convenient to mount the DIMM module 6 in the first slot 11, and incurring no such trouble as that two hands are not sufficient.

II. The vertical projection of the second clasping portion 46 is located in the vertical projection area of the positioning hole 61 at the side edge of the DIMM module 6 mounted in the first slot 11. When the DIMM module 6, after being received into the first slot 11, is rotated downwards to make the positioning hole 61 passes by the second clasping portion 46, the two first fastening members 4 are not excessively pulled, so as to extend the service life of the two first fastening members 4.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A Dual Inline Memory Module (DIMM) connector, comprising:
an electrical receptacle, having a first slot for receiving a first DIMM module to be inserted therein and a second slot for receiving a second DIMM module to be inserted therein, wherein the first slot and the second slot are disposed in a front and back manner in a mating end of the electrical receptacle, and the second slot is higher than the first slot;
at least one first fastening member disposed at one end of the first slot, having a first pressing portion for pressing the first DIMM module, and a first clasping portion for clasping the first DIMM module to prevent the first DIMM module from withdrawing outwards;
at least one second fastening member disposed at one end of the second slot, having a second pressing portion for pressing the second DIMM module; and
at least one second clasping portion clasped at a rear edge of the second DIMM module to prevent the DIMM module from withdrawing outwards.

2. The DIMM connector according to claim 1, wherein the first fastening member further comprises a first fixing portion fixed at one end of the first slot and a first arm portion extending forwards from the first fixing portion.

3. The DIMM connector according to claim 2, wherein the first pressing portion and the first clasping portion are located on the first arm portion.

4. The DIMM connector according to claim 2, wherein the second clasping portion is formed by bending and extending upwards from an upper edge of the first arm portion, and when the first DIMM module is mounted in the first slot, the second clasping portion correspondingly passes through a positioning hole at a side edge of the first DIMM module.

5. The DIMM connector according to claim 2, wherein with a direction facing the first slot being inward, the first arm portion bends and extends inwards to form a first extension plate, and the first extension plate has a first support portion to support upwards the first DIMM module.

6. The DIMM connector according to claim 5, wherein the first extension plate bends and extends outwards and upwards to form a first stop arm, the first stop arm crosses the first arm portion, and is capable of stopping the first arm portion from moving outwards excessively.

7. The DIMM connector according to claim 1, wherein the second fastening member further comprises a second fixing portion fixed at one end of the second slot and a second arm portion extending forwards from the second fixing portion.

8. The DIMM connector according to claim 7, wherein with a direction facing the second slot being inward, the second arm portion bends and extends inwards to form a second extension plate, the second extension plate has a second support portion supporting the second DIMM module, the second extension plate bends and extends outwards and upwards to form a second stop arm, and the second stop arm is capable of stopping the second arm portion from moving outwards excessively.

9. The DIMM connector according to claim 8, wherein the second extension plate further comprises a second soldering portion formed by bending and extending outwards and downwards horizontally from a bottom edge of the second extension plate.

10. The DIMM connector according to claim 7, wherein the second pressing portion is located on the second arm portion, and a vertical projection of the second clasping portion completely falls within a vertical projection area of the positioning hole of the side edge of the first DIMM module.

11. The DIMM connector according to claim 1, wherein the number of the first fastening members and the number of the second fastening members are both 2, the two first fastening members are disposed at two ends of the first slot respectively and opposite to each other, and the two second fastening members are disposed at two ends of the second slot respectively and opposite to each other.

12. A Dual Inline Memory Module (DIMM) connector, comprising:
an electrical receptacle, having a first slot for receiving a first DIMM module to be inserted therein and a second slot for receiving a second DIMM module to be inserted therein, wherein the first slot and the second slot are disposed in the mating end of the electrical receptacle and are horizontally and vertically staggered;
at least one first fastening member, having a first fixing portion fixed at one end of the first slot and a first arm portion extending forwards from the first fixing portion to the front of the first slot, wherein the first arm portion has a first clasping portion for preventing the first DIMM module from withdrawing outwards; and
a second clasping portion, located above the first clasping portion, wherein the second clasping portion and the first clasping portion are disposed one above the other, and the second clasping portion is clasped at a rear edge of the second DIMM module for preventing the second DIMM module from withdrawing outwards.

13. The DIMM connector according to claim 12, further comprising at least one second fastening member, wherein the second fastening member has a second fixing portion fixed at one end of the second slot and a second arm portion extended forwards from the second fixing portion to the front of the second slot.

14. The DIMM connector according to claim 13, wherein the number of the first fastening members and the number of the second fastening members are both 2, the two first fastening members are disposed at two ends of the first slot respectively and opposite to each other, and the two second fastening members are disposed at two ends of the second slot respectively and opposite to each other.

15. The DIMM connector according to claim 13, wherein the second arm portion has a second pressing portion for preventing the second DIMM module from moving upwards.

16. The DIMM connector according to claim 12, wherein the first arm portion further comprises a first pressing portion for preventing the first DIMM module from moving upwards.

17. The DIMM connector according to claim 12, wherein the second clasping portion is located on the first fastening member, and is formed by bending and extending upwards from an upper edge of the first arm portion.

18. The DIMM connector according to claim 12, wherein the first clasping portion is clasped in a positioning hole at a side edge of the first DIMM module, and a vertical projection of the second clasping portion completely falls within a vertical projection area of the positioning hole.

19. The DIMM connector according to claim 12, wherein during an insertion process in which the first DIMM module is mounted in the first slot, the second clasping portion correspondingly passes through a positioning hole at a side edge of the first DIMM module.
